(19) United States
(12) Patent Application Publication
(10) Pub. No.: US 2019/0260657 A1
(43) Pub. Date: Aug. 22, 2019

(54) IN-BAND PERFORMANCE LOSS MEASUREMENT IN IPV6/SRV6 SOFTWARE DEFINED NETWORKS

(71) Applicant: Cisco Technology, Inc., San Jose, CA (US)

(72) Inventors: Clarence Filsfils, Brussels (BE); Rakesh Gandhi, Ontario (CA); Zafar Ali, Hicksville, NY (US); Nagendra Kumar Nainar, Morrisville, NC (US); Carlos M. Pignataro, Cary, NC (US)

(21) Appl. No.: 16/129,967

(22) Filed: Sep. 13, 2018

Related U.S. Application Data
(60) Provisional application No. 62/633,168, filed on Feb. 21, 2018.

(51) Int. Cl. H04L 12/26; H04L 12/931

(52) U.S. Cl. CPC H04L 43/0829; H04L 12/4641; H04L 49/35; H04L 43/12

(57) ABSTRACT

Techniques for in-band loss performance measurement are described. In one embodiment, a method includes assigning one of a first indicator or a second indicator to a first plurality of packets and transmitting the first plurality of packets over a first measurement interval. The method also includes receiving one or more packets and determining whether the received one or more packets are assigned the first indicator or the second indicator. The method further includes determining a loss measurement value for the first plurality of packets based on a difference between a number of packets measured by a first counter of a first network element and a number of packets measured by one of a first counter or a second counter of a second network element.

### CROSS-REFERENCE TO RELATED APPLICATION

This application claims the benefit of priority under 35 U.S.C. § 119 to U.S. Provisional Patent Application Ser. No. 62/633,168, entitled “IN-BAND PERFORMANCE LOSS MEASUREMENT IN IPV6/SRV6 SOFTWARE DEFINED NETWORKS”, filed on Feb. 21, 2018, the disclosure of which application is hereby incorporated by reference in its entirety.

### TECHNICAL FIELD

This disclosure relates generally to network performance loss measurement.

### BACKGROUND

End-user applications are becoming more sensitive to packet loss and operators are moving towards a strict Service Level Agreement (SLA)-based service delivery. In order to provide such strict SLA-based services, operators are required to quickly detect customer data traffic loss and take remedial action (e.g., identifying the faulty path and diverting the traffic over a different path). Segment-routing (SR) is a new technology that greatly simplifies network operations and makes networks Software Defined Network (SDN)-friendly. SR is applicable to both Multiprotocol Switching (MPLS), i.e., SR-MPLS, and Internet Protocol version 6 (IPv6), i.e., SRv6, data planes. Built-in SRv6 Performance Measurement (PM) is an important requirement for the success of this new technology.

### BRIEF DESCRIPTION OF THE DRAWINGS

FIG. 1 is a diagram illustrating a network in which techniques for in-band loss performance measurement may be implemented, according to an example embodiment.

FIG. 2 is an example of a packet header including a 128-bit source-address field, selected bits of which are repurposed as part of the mechanism for in-band loss performance measurement presented herein, according to an example embodiment.

FIG. 3 is a diagram illustrating a Segment Routing Header (SRH) Type Length Value (TLV) for synthetic probes used for in-band loss performance measurement, according to an example embodiment.

FIG. 4 is a diagram illustrating a procedure to inject and punt probe packets in a network for in-band loss performance measurement using a network controller, according to an example embodiment.

FIG. 5 is a flowchart illustrating techniques for in-band loss performance measurement, according to an example embodiment.

FIG. 6 is a diagram illustrating a packet header including a traffic class field, selected bits of which are repurposed as part of the mechanism for in-band loss performance measurement presented herein, according to an additional embodiment.

FIG. 7 is a diagram illustrating a packet header including a Segment Identifier (SID) list, which includes a mechanism for in-band loss performance measurement, according to an additional embodiment.

FIG. 8 is a diagram illustrating a SRH Type Length Value (TLV) for in-band loss performance measurement, according to an additional embodiment.

FIG. 9 is a diagram illustrating a hashing of Segment Identifiers (SIDs) in a SRH stack, which includes a mechanism for in-band loss performance measurement, according to an additional embodiment.

FIG. 10 is a diagram illustrating an egress node allocating a flow-ID SID that includes a mechanism for in-band loss performance measurement, according to an additional embodiment.

FIG. 11 is a diagram illustrating an egress node allocating virtual private network (VPN) SIDs for in-band loss performance measurement, according to an additional embodiment.

FIG. 12 is a diagram illustrating a packet header including a flow label field and a traffic class field, a selected bit of which is repurposed as part of the mechanism for in-band loss performance measurement presented herein, according to an additional embodiment.

FIG. 13 is a block diagram of a pair of network elements for implementing techniques for in-band loss performance measurement, according to an example embodiment.

FIG. 14 is a block diagram of a network controller for implementing in-band loss performance measurement in a network, according to an example embodiment.

### DESCRIPTION OF EXAMPLE EMBODIMENTS

### Overview

Presented herein are techniques for in-band loss performance measurement in IPv6/SRv6 SDNs. In an example embodiment, a method includes assigning, at a first network element, one of a first indicator or a second indicator to a first plurality of packets. The method also includes transmitting, from the first network element, the first plurality of packets over a first measurement interval. The first network element includes a first counter that measures a number of packets of the first plurality of packets transmitted by the first network element during the first measurement interval. The method also includes receiving, at a second network element, one or more packets from the first network element and determining whether the received one or more packets are assigned the first indicator or the second indicator. The second network element includes a first counter that measures a number of packets received by the second network element that are assigned the first indicator and a second counter that measures a number of packets received by the second network element that are assigned the second indicator. The method further includes determining a loss measurement value for the first plurality of packets based on a difference between the number of packets measured by the first counter of the first network element and the number of packets measured by one of the first counter or the second counter of the second network element.

### Example Embodiments

SRv6 policies are used to steer traffic through a specific, user-defined path using a stack of Segment Identifiers (SIDs). One typical customer requirement is to verify that the traffic is arriving at the egress nodes of the SRv6 policy. In SRv6 SDNs, there is a requirement to measure customer traffic and detect any packet loss in-band in the data plane (known as direct mode) sent on SRv6 policies. Network operators would like to obtain data on performance traffic counters/loss to enable the Operations Administration and Management/Performance Monitoring (OAM/PM) use-cases on a centralized controller. Examples of such OAM/PM uses cases include: in-hand traffic loss measurement for end-to-end SRv6 policy; in-band traffic loss measurement for SR links; centralized controller-based use-cases for OAM and Netflow based traffic stats collection as well as synthetic probe based measurements for in-band traffic loss. Performance loss measurement and monitoring by the centralized controller then can be used for SLAs.

The principles of the example embodiments described herein provide a practical solution that can be implemented in hardware microcode and, therefore, is lightweight. Moreover, the example embodiments describe a solution that does not degrade forwarding performance significantly and at the same time does not consume excessive memory.

Internet Engineering Task Force (IETF) publication RFC 6374 sets forth different modes of Loss Measurement (LM). The LM protocol can perform two distinct kinds of loss measurement: Inferred Mode (out-of-band) and Direct Mode (in-band). The Inferred Mode (i.e., out-of-band) involves measuring the loss of specially generated test messages in order to infer the approximate data plane loss level. This Inferred Mode loss measurement provides only approximate loss accounting. The Direct Mode (i.e., in-band) directly measures data plane packet loss. This Direct Mode loss measurement provides perfect loss accounting, but may require hardware support. Thus, while RFC 6374 defines a packet format for LM probe packets, it does not define a procedure for accounting and correlating traffic on two network elements or nodes.

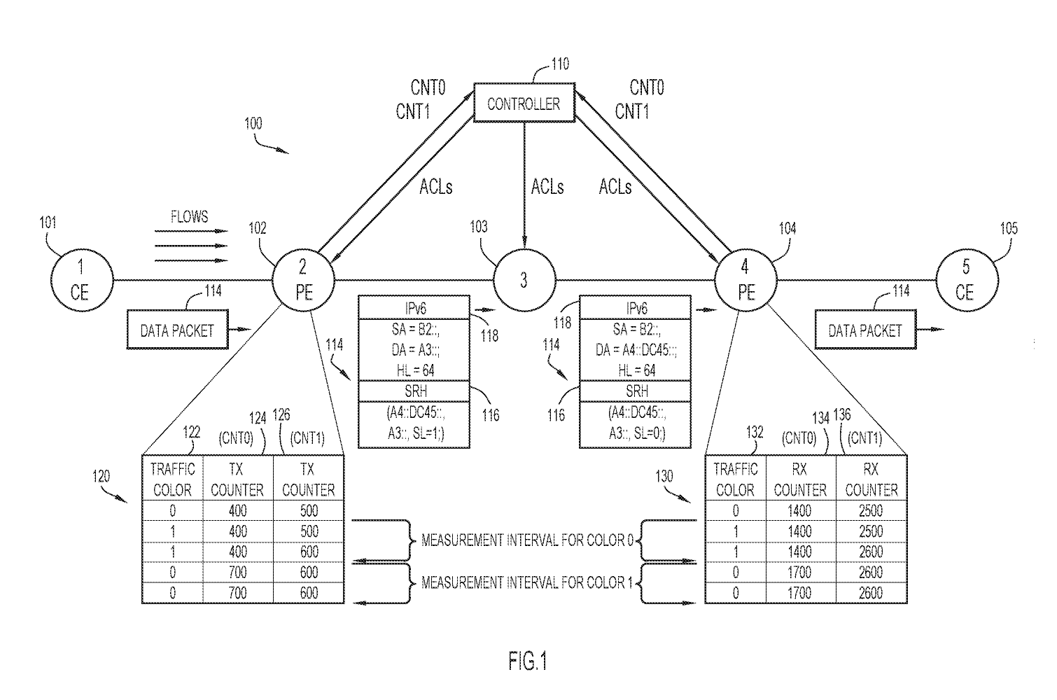

The example embodiments described herein provide techniques for in-band loss performance measurement in a network, for example, IPv6/SRv6 software defined networks (SDNs), where packet loss is measured directly in the data plane. Referring now to FIG. 1, a network 100 in which techniques for in-band loss performance measurement may be implemented is shown according to an example embodiment. For example, in some embodiments, network 100 may be an IPv6 or SRv6 SDN.

In this embodiment, network 100 includes a plurality of network elements or nodes, including a first customer edge node 101, a first network element 102, an intermediate network element 103, a second network element 104, and a second customer edge node 105. In this embodiment, customer edge nodes 101, 105 may be a network element (e.g., a router) that is located on a customer's premises that provides an interface to/from a provider's core network. For example, in this embodiment, the provider's core network may be represented by first network element 102, intermediate network element 103, and second network element 104 of network 100. Additionally, network 100 may further include a network controller 110 that provides monitoring, control, and management operations to one or more components of network 100, including first network element 102, intermediate network element 103, and second network element 104.

In various embodiments, network elements or nodes of network 100 may be endpoints of any of a variety of types, such as routers, servers, switches, data storage devices, gateways, as well as networking appliances, such as firewalls, intrusion detection systems, etc. The endpoints may be physical, virtual (e.g., implemented in software), or a combination of both. In an example embodiment, first network element 102 and second network element 104 may be routers that are configured to route packets through network 100, including routing packets between first customer edge node 101 and second customer edge node 105.

The techniques for in-band loss performance measurement described herein may use the following terms and terminology throughout this description and claims:

Color: One or more packets of a packet flow or traffic may be assigned a color, which serves as an indicator to identify or mark the packets of the packet flow or traffic. In the example embodiments, a packet may be marked with one of two different colors or indicators. In other words, each packet is marked with one color or indicator or the other. As will be described in more detail below, a bit in a packet header may be used as an identifier of the color or indicator assigned to the particular packet. The color assigned to packets may be periodically toggled between the two options during a measurement interval. During each measurement interval, information may be collected from counters that detect a number of packets sent with the color assigned during the previous measurement interval for correlation (i.e., loss performance measurement determination) between the number of packets transmitted and the number of packets received. In addition, in other embodiments, more than two indicators/colors may be used. For example, two bits may be used to identify an indicator/color with four possible values or options for the indicator/color.

Flow-ID: A flow identifier (flow-ID) may be used to uniquely identify the SRv6 policy from a source address. The flow-ID may also be referred to as the policy-ID.

Source address: The source address identifies the source node of the packets of a packet flow or traffic.

Access Control List (ACL): ACLs are provided at each of an ingress node (i.e., the network element at which the SRv6 policy is instantiated) and an egress node (i.e., the network element at which the SRv6 policy is terminated) to count packets based on the information in the fields of the packet headers, such as, Color, Flow-ID, and Source address. In the example embodiments, two ACLs are needed at each node, one ACL to count packets of one color and another ACL to count packets of the other color.

Referring back to FIG. 1, in this embodiment, a packet flow or traffic 112 originates from customer edge node 101. Packet flow 112 comprises a plurality of packets, including a first packet 114. In this embodiment, first packet 114 is received by first network element 102, where a Segment Routing Header (SRH) 116 is added to first packet 114 and an outer IPv6 header 118 is also added to first packet 114. First network element 102 is the source node for the SRv6 policy, for example, initiated by network controller 110. Accordingly, the SRv6 policy is instantiated by first network element 102, which is considered the ingress node for the policy.

The outer IPv6 header 118 of first packet 114 allows first network element 102 to customize one of more fields in IPv6 header 118 to enable the functionality of the techniques for in-band loss performance measurement described herein without affecting the inner IPv6 header that is already present in first packet 114 from customer edge node 101. In this embodiment, a source address field in outer IPv6 header 118 of first packet 114 is used by first network element 102 to indicate a color and mark the flow-ID (e.g., the SRv6 policy ID) in accordance with the SRv6 policy.

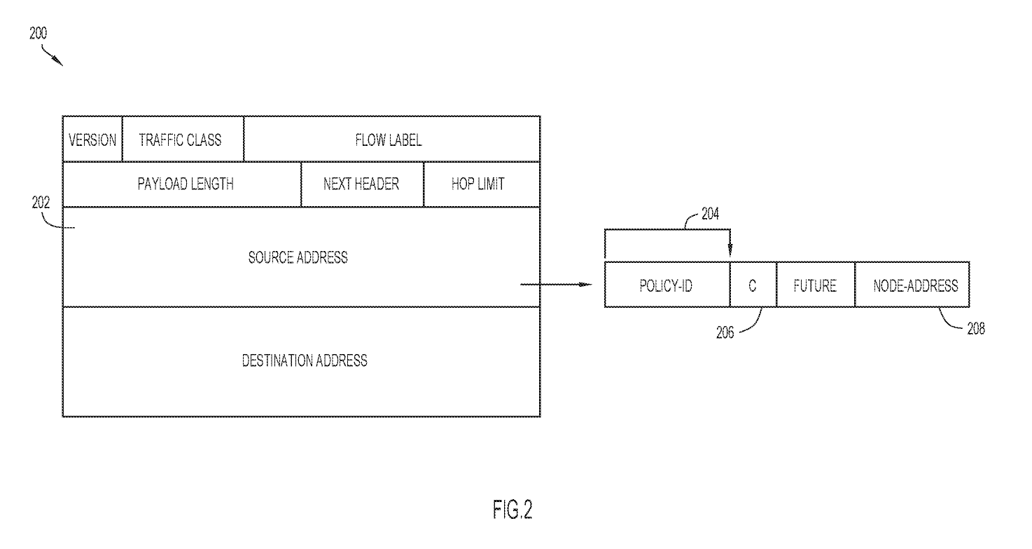

FIG. 2 illustrates an example of a packet header 200 including a 128-bit source-address field 202, selected bits of which are repurposed as part of the mechanism for in-band loss performance measurement presented herein, according to an example embodiment. In this example, techniques for in-band loss performance measurement may use bits from source-address field 202 of packet header 200 to include information associated with an assigned indicator/color for a packet, as well as to identify the SRv6 policy via a policy-ID. Depending on the prefix/mask used in network 100, 64-bits may be sufficient to identify the source node in network 100, for example, using a node address 208 of source-address field 202. Accordingly, 32-bits of source-address field 202 may be used to identify a flow-ID that indicates a policy-ID 204 associated with the local SRv6 policy. Additionally, one bit from source-address field 202 may be used to identify an indicator/color 206 assigned to a packet. As described above, in other embodiments, two bits in a packet header (e.g., source-address field 202) may be used to assign more than two indicators/colors to packet. For example, by using two bits, a packet may be assigned an indicator/color with four possible values or options.

Referring again to FIG. 1, in this embodiment, first network element 102 may assign a first indicator or color to first packet 114 (e.g., traffic color=0) during a first measurement interval. As previously described, the ingress node (i.e., first network element 102) and the egress node (i.e., second network element 104) each include two ACLs, one for each color or indicator assigned to packets begin transmitted over network 100. In this embodiment, first network element 102 includes a stored table or data structure 120 that includes an identifier for traffic indicator or color 122, a first counter 124 configured to count a number of packets assigned to a first indicator or color (e.g., CNT0), and a second counter 126 configured to count a number of packets assigned to a second indicator or color (e.g., CNT1).

Similarly, second network element 104 also includes a stored table or data structure 130 that includes an identifier for traffic indicator or color 132, a first counter 134 configured to count a number of packets assigned to a first indicator or color (e.g., CNT0), and a second counter 136 configured to count a number of packets assigned to a second indicator or color (e.g., CNT1).

In one embodiment, a centralized controller (e.g., network controller 110) is used to attach the two ACLs on the ingress node (i.e., first network element 102) and two ACLs on the egress node the egress node (i.e., second network element 104) of a SRv6 policy, as shown in FIG. 1. Each of these two ACLs are used to count packets (and bytes) against the source address in the outer IPv6 headers of each packet (e.g., outer IPv6 header 118 of first packet 114), with two values, one for each indicator or color assigned to the packets. These ACL counters (for packets and bytes) are used at end-point nodes for accounting traffic for loss performance measurement.

In other embodiments, the SRv6 policy and ACLs may be set up manually, for example, by an administrator of network 100. In still other embodiments, the SRv6 policy and ACLs may be initiated using by implementing Traffic Engineering via a Border Gateway Protocol (BGP-TE) or other suitable protocol.

In an example embodiment, the ingress node (i.e., first network element 102) toggles a bit that serves an identifier of the indicator or color to be assigned to packets on all linecards (LCs) at approximately the same time at every periodic measurement interval as shown in FIG. 1. For example, during a first measurement interval, first network element 102 assigns a first indicator (e.g., color=1) to packets of a plurality of packets from traffic 112. During this first measurement interval, counters at first network element 102 and second network element 104 associated with the other indicator or color (e.g., color=0) are frozen. Similarly, during a second measurements interval, first network element 102 assigns a second indicator (e.g., color=0) to packets of a plurality of packets from traffic 112. During this second measurement interval, counters at first network element 102 and second network element 104 associated with the first indicator or color (e.g., color=1) are frozen.

In an example embodiment, the periodic measurement interval may be a predetermined amount of time. For example, in one embodiment, the measurement intervals may be approximately every 2 minutes. Thus, the indicator or color assigned to the incoming packets at the ingress node (i.e., first network element 102) are toggled between the two indicators/colors every two minutes. In other embodiments, the predetermined amount of time may be shorter or longer, and, in some cases, may be based on the amount of traffic or number of packets received in packet flow 112 from first customer edge node 101.

Due to toggling of the bit that serves as an identifier of the indicator/color in a source address of the SRv6 policy, it may appear on the egress node (i.e., second network element 104) that two separate sources are sending traffic on the SRv6 policy. In this embodiment, the flow-ID is used for Equal Cost Multipath (ECMP) hashing and, therefore, toggling a bit that identifies an indicator/color will not cause any issue in network 100.

During each successive measurement interval, counters (packets or bytes) for the traffic sent with previous indicator or color (at the time of the indicator/color change) for an SRv6 policy can be sent via event driven telemetry (EDT) to network controller 110 for measuring and detecting packet loss for determining a loss measurement value. For example, as shown in FIG. 1, during the first measurement interval, first network element 102 and second network element 104 may send counters associated with the first indicator or color to network controller (i.e., first counter 124 (CNT0) from first network element 102 and first counter 134 (CNT0) from second network element 104). Similarly, during the second measurement interval, first network element 102 and second network element 104 may send counters associated with the second indicator or color to network controller (i.e., second counter 126 (CNT1) from first network element 102 and second counter 136 (CNT1) from second network element 104). In this embodiment, the counters at first network element 102 are independent from the counters at second network element 104 (i.e., they are not synchronized).

In an example embodiment, network controller 110 may use the received counters from first network element 102 and second network element 104 to determine a loss measurement value for the plurality of packets assigned to each indicator or color based on a difference between the number of packets measured by the counters of first network element 102 and the number of packets measured by the corresponding counters of second network element 104. For example, network controller 110 may determine a loss measurement value for a first plurality of packets assigned to a first indicator/color (e.g., color=0) based on a difference between the number of packets measured by first counter 124 (CNT0) of first network element 102 and the number of packets measured by first counter 134 (CNT0) of second network element 104. Similarly, network controller 110 may determine a loss measurement value for a second plurality of packets assigned to a second indicator/color (e.g., color=1) based on a difference between the number of packets measured by second counter 126 (CNT1) of first network element 102 and the number of packets measured by second counter 136 (CNT1) of second network element 104.

According to this example, the number of packets measured by first counter 124 (CNT0) of first network element 102 during the first measurement interval is 300 (i.e., the change in the number of packets counted between successive measurement intervals—400 v. 700) and the number of packets measured by first counter 134 (CNT0) of second network element 104 during the first measurement interval is also 300 (i.e., the change in the number of packets counted between successive measurement intervals—1400 v. 1700). Thus, the loss measurement value for the first plurality of packets assigned to the first indicator or color is zero. Similarly, the number of packets measured by second counter 126 (CNT1) of first network element 102 during the second measurement interval is 100 (i.e., the change in the number of packets counted between successive measurement intervals—500 v. 600) and the number of packets measured by second counter 136 (CNT1) of second network element 104 during the second measurement interval is also 100 (i.e., the change in the number of packets counted between successive measurement intervals—2500 v. 2600). Thus, the loss measurement value for the second plurality of packets assigned to the second indicator or color is also zero.

Additionally, the techniques for in-band loss performance measurement described herein also allow for accounting traffic at one or more transit nodes of SRv6 policies using the same ACLs setup by a centralized controller for two colors/indicators without requiring any state for the SRv6 policy at the transit nodes. For example, as shown in FIG. 1, a transit node, such as intermediate network element 103, may also receive ACLs from network controller 110. Thus, while the SRv6 policy for in-band loss performance measurement is instantiated on the ingress node (e.g., first network element 102) and terminates on the egress node (e.g., second network element 104), one or more nodes in network 100 disposed between the ingress node and the egress node, such as intermediate network element 103, may also include ACLs with counters that keep track of the number of packets transmitted and received for each of the two indicators/colors assigned to the packets. The techniques described herein are compatible with any transmit behavior of the transit nodes (e.g., intermediate network element 103), including both T.Encap and T.Insert transit action of the SRv6 policy taken by the transit nodes.

In different embodiments, determining the loss measurement value may be implemented using a variety of mechanisms by different entities. In the example embodiments, the determination of the loss measurement value for the plurality of packets is initiated by a central controller of the network, for example, network controller 110 of network 100. In these embodiments, the central controller may pull (i.e., request) the values of the counters from the ingress node (e.g., first network element 102) and the egress node (e.g., second network element 104), or may receive a push notification of the values of the counters from each node. In other embodiments, the determination of a loss measurement value may be made locally at one of the ingress/egress nodes, for example, at one of first network element 102 or second network element 104. In these embodiments, the node may use a synthetic probe packet to request and receive the values of the counters from the other node to make the determination of the loss measurement value.

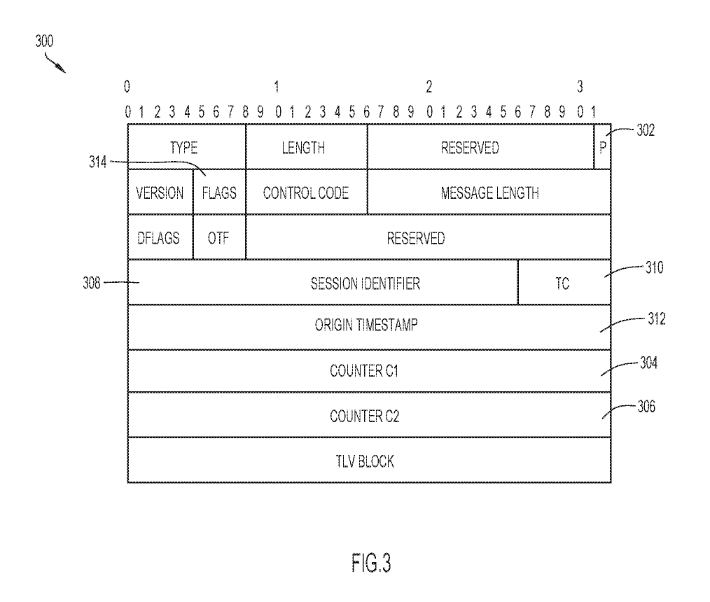

FIG. 3 is a diagram illustrating a Segment Routing Header (SRH) 300 Type Length Value (TLV) for synthetic probes used for in-band loss performance measurement, according to an example embodiment. In this embodiment, a new TLV Type is defined for SRH 300 for loss measurement (LM), denoted LM TLV. This LM TLV may be carried by one or more synthetic probe packets used by nodes in network 100 (e.g., first network element 102 and/or second network element 104) to locally determine a loss measurement value for packet traffic. As shown in FIG. 3, LM TLV of SRH 300 has the following key fields, including, but not limited to: a color field 302, a first traffic counter field 304, a second traffic counter field 306, a session identifier field 308, a traffic class field 310, an origin time-stamp field 312, and a flag field 314.

In this embodiment, color field 302 uses 1-bit (denoted by P, in FIG. 3) as an identifier of the color or indicator associated with the counters in the LM TLV. For example, when LM TLV of SRH 300 includes counters associated with a first indicator or color (e.g., first counter 124 of first network element 102 and first counter 134 of second network element 104, CNT0), then color field 302 will include a bit identifier for the first indicator/color (i.e., color=0).

Next, first traffic counter field 304 includes the number or value (i.e., measured in packets or bytes) for the transmit (TX) traffic counter (e.g., one of first counter 124 (CNT0) or second counter 126 (CNT1) at first network element 102) at the time of the indicator/color change. That is, the number or value of the counter when the ingress node (e.g., first network element 102) toggles the assignment from one indicator/color to the other. Similarly, second traffic counter field 306 includes the number or value for the receive traffic counter at the egress node (e.g., one of first counter 134 (CNT0) or second counter 136 (CNT1) at second network element 104) at the time of the indicator/color change.

Session identifier field 308 includes information that identifies the SRv6 policy under loss performance measurement and is used by the under loss performance measurement process in the control plane. Traffic class field 310 indicates the traffic class being measured for traffic loss by the loss performance measurement process. Origin time-stamp field 312 includes a time stamp for the packet, which time stamp may be in a known format, for example, Network Time Protocol (NTP) or Precision Time Protocol (PTP), as defined by The Institute of Electrical and Electronics Engineers (IEEE) 1588v1 standard. Lastly, SRH 300 includes flag field 314, which may include information that indicates whether the packet is a query packet or a reply packet. Additionally, SRH 300 may include other known fields.

For loss performance measurement between nodes in network 100, counter values are determined for each of the transmit (TX) and the receive (RX) sides between two nodes over which the loss performance measurement is to be determined. Linecards (LCs) for each node can add counter stamps in the LM TLV in the SRH. For example, as shown in FIG. 3, first traffic counter field 304 and second traffic counter field 306 of SRH 300 may be used to provide information associated with each of the transmit and receive counters associated with a given indicator/color.

The techniques for in-band loss performance measurement described herein include a Segment ID (SID) Function END.LMP (Loss Measurement Punt) that is carried by synthetic probes for Direct Mode (i.e., in-band) performance loss measurement. The SID value for the END.LMP Function is advertised via the Internal Gateway Protocol (IGP) by the egress node (e.g., second network element 104, shown in FIG. 1 above). The SID value indicates that the node supports loss measurement. The SID value may then be used by the ingress node (e.g., first network element 102, shown in FIG. 1) to punt a synthetic probe query on the egress node to receive information associated with counter values for loss measurement value determination. END.LMP is added in the loss performance measurement probe packets to punt packets on the egress node.

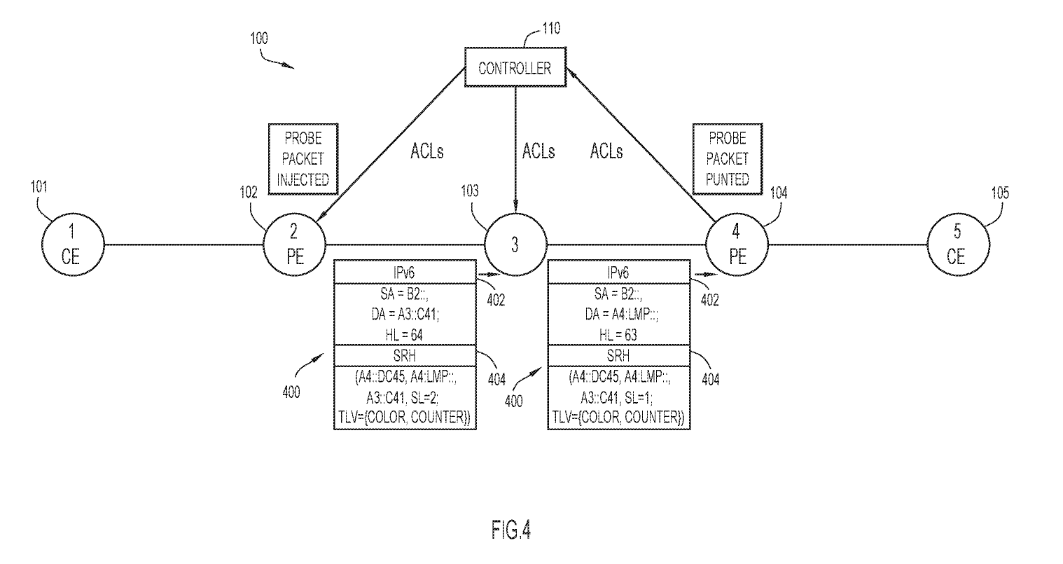

Reference is now made to FIG. 4 for a description of a procedure for using synthetic probes for loss performance measurement. In this embodiment, network 100 includes network controller 110 and first customer edge node 101, first network element 102, intermediate network element 103, second network element 104, and second customer edge node 105, as described above with reference to FIG. 1.

In this embodiment, a probe query packet 400, including an outer IPv6 header 402 and a SRH 404, is sent at every measurement interval by the loss performance measurement process in the control plane. For example, probe query packet 400 may be sent with SRH 404 that includes SID Function END.LMP received from the egress node (e.g., second network element 104) via an IGP advertisement to punt the probe packets on the egress node. In this embodiment, probe query packet 400 is injected at the ingress node (e.g., first network element 102). Probe query packets, for example, probe query packet 400, may be sent to the next-hop with following information provided in each of the headers: outer IPv6 header 402 includes a destination address set to identify the egress node where the probe packet 400 will be punted (e.g., DA=An:END.LMP), and SRH 404 contains a SID list of {An:END.LMP} with SL=0 and the LM TLV.

For example, as shown in FIG. 4, the egress node is second network element 104, therefore, probe query packet 400 includes outer IPv6 header 402 that includes DA=A4:END.LMP and SRH 404 that includes a SID list of {A4:END.LMP} and the LM TLV that includes an identifier of the indicator/color of the packets being evaluated for loss performance measurement and the associated counters for that indicator/color.

In some embodiments, probe query packets, for example, probe query packet 400, may be prepared by the loss performance measurement process in the control plane or a controller (e.g., network controller 110) with the required SID stack including END.LMP, as shown in SRH 404. Hence, a SID stack depth limitation does not apply to them. The LM TLV in SRH 404 (as described in reference to FIG. 3) is added by the loss performance measurement process in the control plane and the hardware in network 100 does not need to process this LM TLV.

In this embodiment, probe query packet 400 does not contain any payload and Next-header in probe query packet 400 is set to NONE. The loss performance measurement process in the control plane on the ingress node (e.g., first network element 102), where probe query packet 400 originates, collects the transmit (TX) counters for the previous indicator/color from all LCs (e.g., one of first counter 124 (CNT0) or second counter 126 (CNT1) at first network element 102, depending on which was associated with the previous indicator/color), aggregates the counters, and sends the counter information (i.e., values in packets and/or bytes) in the LM TLV of probe query packet 400. For example, the transmit (TX) counter information may be included in a first traffic counter field of SRH 404 of probe query packet 400.

The loss performance measurement process in the control plane on the egress node (e.g., second network element 104), which is responding to probe query packet 400, triggers collection of the receive (RX) counters for the previous indicator/color from all LCs of the SRv6 policy (e.g., one of first counter 134 (CNT0) or second counter 136 (CNT1) at second network element 104, depending on which was associated with the previous indicator/color), and aggregates them. The loss performance measurement process in the control plane at the egress node (e.g., second network element 104) sends an Internet Protocol/User Datagram Protocol (IP/UDP) reply according to the RFC 6374 packet format (as described above) as a payload to the ingress node (e.g., first network element 102) that initiated probe query packet 400. This reply packet contains information associated with both counters for the previous indicator/color, i.e., the transmit (TX) counters and the receive (RX) counters. For example, the receive (RX) counter information may be included in a second traffic counter field and the transmit (TX) counter information may be included in the first traffic counter field of the replay packet.

A reply packet in response to probe query packet 400 may be sent to a central controller (e.g. network controller 110), either via locally configuring the central controller's IP address or by using the central controller's IP address received in probe query packet 400 (e.g., an IP/UDP Reply TLV containing the central controller address) in the LM TLV as an IP/UDP message.

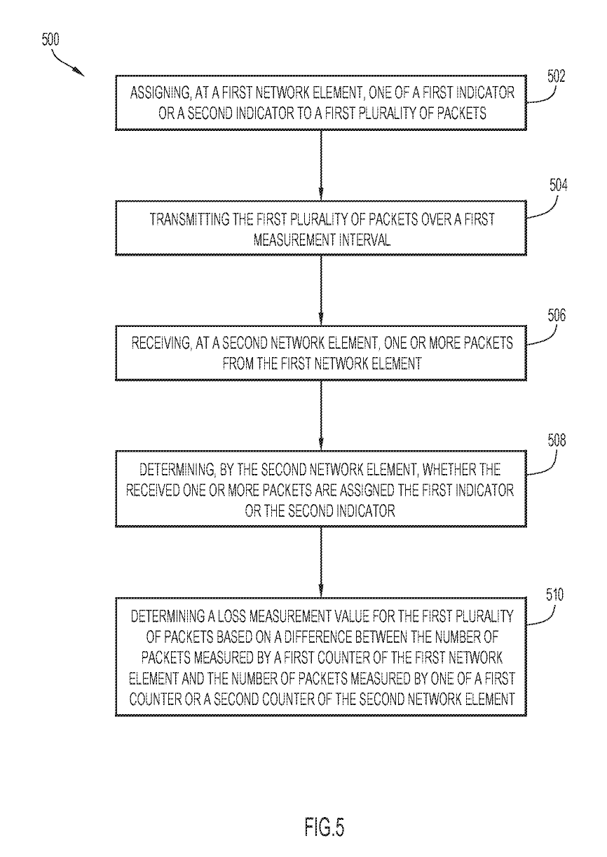

FIG. 5 is a flowchart of a method 500 for implementing techniques for in-band loss performance measurement in network 100, according to an example embodiment. In this embodiment, method 500 may be implemented by ingress and egress nodes in a network, for example, first network element 102 and second network element 104, described above. Additionally, method 500 may be implemented concurrently by multiple nodes in network 100, for example, to measure loss measurement values between different pairs of ingress and egress nodes in a network.

In this embodiment, method 500 may begin at an operation 502 where a first network element or an ingress node assigns one of a first indicator/color or a second indicator/color to a first plurality of packets. As used herein and in the claims, the term packet may be used in a generic sense to include packets, frames, segments, datagrams, and/or other generic data units that may be used to transmit data and/or commands in a network. For example, as shown in FIG. 1, first network element 102 may be the ingress node for traffic or packet flow 112 from first customer edge node 101 that includes a first plurality of packets, which are assigned an indicator/color by first network element 102.

Next, at an operation 504, method 500 includes transmitting the first plurality of packets from the first network element over a first measurement interval. Operation 504 also includes measuring, at the first network element, the number of packets of the first plurality of packets assigned to the designated first indicator/color or second indicator/color that are transmitted by the first network element during the first measurement interval using an associated counter for that indicator/color. For example, as shown in FIG. 1, first network element 102 includes stored table or data structure 120 with first counter 124 (CNT0) for measuring packets associated with the first indicator/color and second counter 126 (CNT1) for measuring packets associated with the second indicator/color.

Next, method 500 includes an operation 506 where one or more packets from the first network element (i.e., the ingress node) are received by a second network element or an egress node. Method 500 also includes an operation 508, where the second network element determines whether the received packets are assigned the first indicator/color or the second indicator/color. For example, as shown in FIG. 1, second network element 104 receives one or more packets from the first plurality of packets transmitted or sent by first network element 102 and second network element 104 then determines which identifier/color (i.e., first indicator/color=0, or second indicator/color=1) has been assigned to the packets. Each packet of the plurality of packets may include an identifier of the assigned indicator/color, which may be located in the packet header, as described in the various embodiments herein.

Operation 508 of method 500 also includes measuring, at the second network element, the number of packets of the first plurality of packets assigned to the designated first indicator/color and/or second indicator/color that are received at the second network element using an associated counter for each indicator/color. For example, as shown in FIG. 1, second network element 104 includes stored table or data structure 130 with first counter 134 (CNT0) for measuring packets associated with the first indicator/color and second counter 136 (CNT1) for measuring packets associated with the second indicator/color.

Method 500 further includes an operation 510 where a loss measurement value for the first plurality of packets is determined. Operation 510 includes determining the loss measurement value for the first plurality of packets based on a difference between the number of packets measured by the first counter of the first network element and the number of packets measured by one of the first counter or the second counter of the second network element. For example, where the first plurality of packets are assigned to the first indicator/color, determining the loss measurement value at operation 510 includes determining the difference between the number of packets measured by first counter 124 (CNT0) at first network element 102 and the number of packets measured by first counter 134 (CNT0) at second network element 104. As described above, counters may measure packets by number and/or bytes, with the resulting calculation of the loss measurement value being determined in corresponding units.

In some embodiments, operation 510 may be performed by a central controller (e.g., network controller 110), which receives the counters from the ingress node and the egress node (e.g., first network element 102 and second network element 104). In other embodiments, however, operation 510 may be performed by a node in the network by using a probe query packet (e.g., probe query packet 400) to obtain the relevant counters from the other node in the network, as described above.

Upon performing method 500 to determine one or more loss measurement values, a responsive action may be taken, for example, by network controller 110 and/or one or more nodes, including first network element 102 and/or second network element 104. Responsive actions include, but are not limited to: changing a path for a packet flow (e.g., a path protection switchover), signal a failure to a network administrator or other controller, instantiate a new path between nodes, diverting traffic, implementing a new policy, as well as other actions that may mitigate or correct any packet loss determined based on the loss performance measurement techniques described herein.

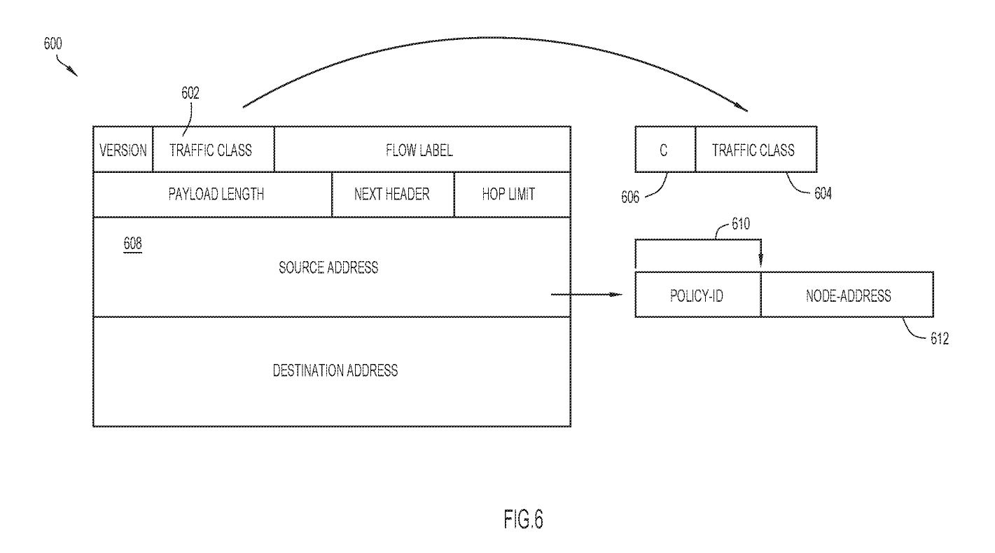

A variety of different mechanisms may be used according to the principles of the example embodiments described herein to provide the information “in-band” with packets to allow for in-band loss performance measurement described above in connection with FIGS. 1-5. The following FIGS. 6-12 describe alternate embodiments for these mechanisms.

Referring to FIG. 6, a packet header 600 including a traffic class field 602, selected bits of which are repurposed as part of the mechanism for in-band loss performance measurement presented herein, is shown according to an additional embodiment. In this embodiment, packet header 600 may be an IPv6 header that includes, among other conventional fields, at least traffic class field 602 and a source address field 608, which are used for in-band loss performance measurement. Traffic class field 602 may have 8-bits, which are used to provide conventional traffic class information in a first portion 604 and a single bit 606 that is used for an identifier for an indicator/color assigned to a packet. Additionally, source address field 608 of packet header 600 may have 128-bits, 32-bits of which may be used for a flow-ID 610 that is used to designate the relevant policy-ID for in-band loss performance measurement. The remaining portion of source address field 608 may be used for a node address 612 to identify a source node.

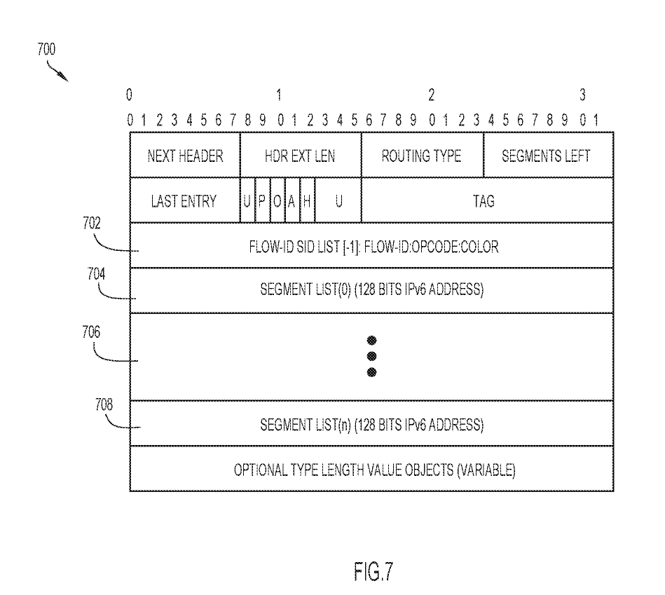

FIG. 7 illustrates a packet header 700 including a Flow-ID Segment Identifier (SID) list 702, which includes a mechanism for in-band loss performance measurement, according to an additional embodiment. In this embodiment, packet header 700 is a SRH that includes a new Flow-ID SID list 702 that is allocated by the ingress node and added before the first SID list on the stack in the SRH 700. For example, as shown in FIG. 7, Flow-ID SID list 702 is added before a first SID list 704 of a stack that also includes SID lists 706, 708. In this embodiment, Flow-ID SID list 702 includes the following information: SID:Locator:=Add Flow-ID (used to identify the relevant Policy ID for loss performance measurement), SID:Function:OpCode:=Add “count packets” (value TBD), and SID:Function:Arg:=Add indicator/color flag (used to identify the assigned indicator/color of the packet).

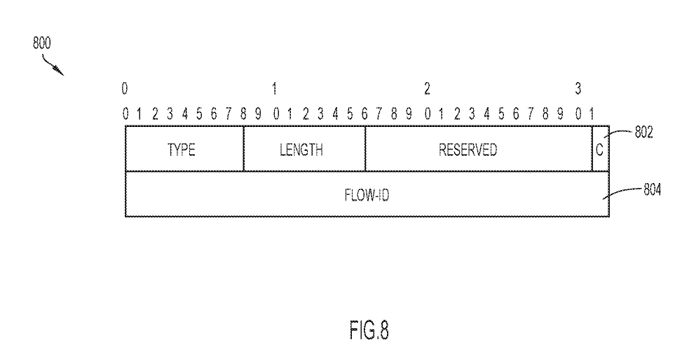

FIG. 8 illustrates a SRH 800 with a Type Length Value (TLV) for in-band loss performance measurement, according to an additional embodiment. In this embodiment, SRH 800 includes a LM TLV with a color field 802 for an identifier of the indicator/color assigned to a packet and a Flow-ID field 804 that is used to identify the relevant Policy ID for loss performance measurement.

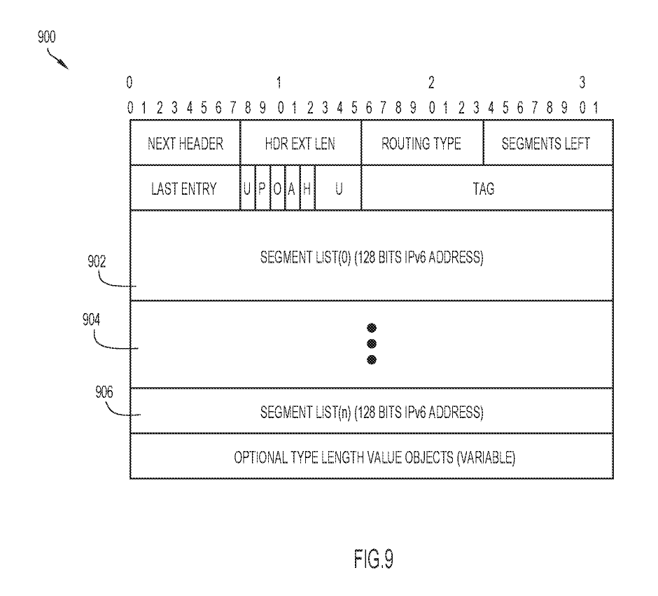

FIG. 9 illustrates a SRH 900 with a hashing of Segment Identifiers (SIDs) in the stack, which includes a mechanism for in-band loss performance measurement, according to an additional embodiment. In this embodiment, a hash-key (e.g., 64-bits) may be created using the SID lists in the stack of SRH 900. For example, as shown in FIG. 9, a hash-key may be created using a first SID list 902, a second SID list 904, and a third SID list 906. The hash-key may be programmed in advance at the ingress node and egress node of the SRv6 policy. In this embodiment, the hash key is created from each data packet to count the packets for in-band loss performance measurement and a bit in a flag field of SRH 900 may be used for an identifier of the indicator/color assigned to a packet. With this arrangement, counters measure the packets based on the hash keys.

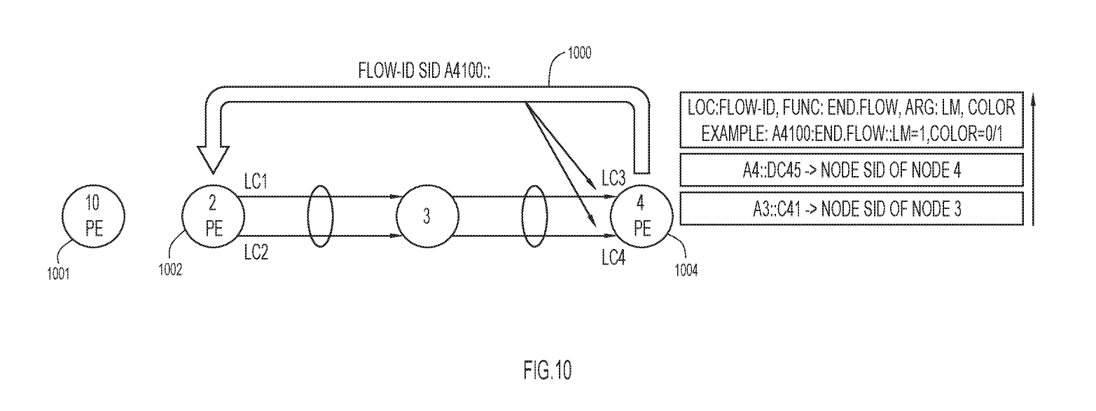

FIG. 10 illustrates an egress node 1004 allocating a flow-ID SID 1000 that includes a mechanism for in-band loss performance measurement, according to an additional embodiment. In this embodiment, egress node 1004 is where the relevant SRv6 policy terminates (e.g., for loss performance measurement) and egress node 1004 needs to know or be informed on which SRv6 policy traffic is being received. For example, from a first node 1001 or a second node 1002. The egress node 1004 allocates an incoming SID for flow-ID (e.g., flow-ID SID 1000 (A4100::)) that is locally unique on that node for each SRv6 policy that terminates locally at egress node 1004. This will increase the SID stack depth by one and is used only when loss performance measurement is enabled on the SRv6 policy. The flow-ID SID 1000 identifies the associated SRv6 policy terminated on egress node 1004. The flow-ID SID 1000 may also be used for other use cases, such as bi-directional policies and/or flex-Isp. Flow-ID SID 1000 can also account for traffic received on that SRv6 policy at egress node 1004. Egress node 1004 may advertise the function END.FLOW Opcode to detect the presence of flow-ID SID 1000. This SID Function END.FLOW indicates the presence of flow-ID SID 1000 in the LOC field in SRv6 SID. In some embodiments, SID Function END.FLOW may be optional.

Additionally, the function argument (ARG) may optionally contain flags to identify loss performance management and the assigned indicator/color. For example, as shown in FIG. 10, ingress node 1002 sends traffic using flow-ID SID 1000 at the bottom of the SID list with an indicator/color flag (e.g., indicator/color=0) included in the argument field (ARG) for a measurement interval. At the next measurement interval, ingress node 1002 sends traffic with the other indicator/color flag (e.g., indicator/color=1). This toggling of indicator/color continues for each successive measurement interval.

FIG. 10 may also be described with reference to an example scenario. In this embodiment, a centralized controller (e.g., network controller 110) instructs egress node 1004 to allocate two loss performance measurement sibling SIDs for a given END/DX/DT SID (e.g., S). Egress node 1004 generates two clones of the target egress SID (e.g., S1 and S2). Each of S1 and S2 have the same exact pseud-code as S, with the difference in that each counter tracks a different color/indicator of traffic. In particular, the per-SID counters of S1 and S2 only track the packets with these SIDs. According to this scenario, no new traffic accounting is performed at egress node 1004, only the existing per-local SID counter is used. Additionally, coloring the traffic with an indicator/color is not needed via Differentiated Services Code Point (DSCP)/Flowlabel, because the SIDs are already colored with the appropriate indicator/color for the traffic. Ingress node 1002 installs two segment lists (SLs), one for each SID associated with either indicator/color, and periodically swaps for one or the other (i.e., at each measurement interval). With this arrangement, ingress node 1002 may perform traffic accounting leveraging Per-Segment-List Aggregate traffic counters (POL.SL). A centralized controller (e.g., network controller 110) may collect traffic counters for both SIDs from ingress node 1002 and egress node 1004.

In this embodiment, flow-ID SID 1000 may be signaled to the ingress node (e.g., second node 1002) using a variety of different mechanisms, including, but not limited to: via a Path Computation Element (PCE) or controller, using BGP-TE, and/or via configuration.

In various embodiments, the SID advertised by egress node 1004 for traffic accounting purposes may a virtual private network (VPN) SID and/or a SID intended for other use cases. Additionally, in other embodiments, multiple SIDs may be present, with one or more of the multiple SIDs used for traffic accounting.

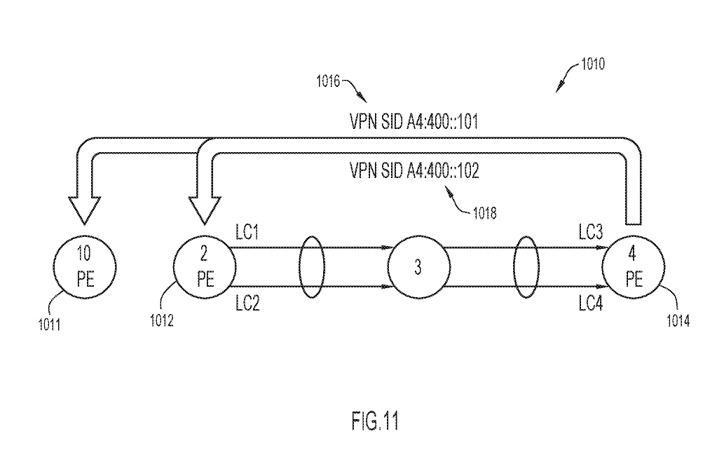

FIG. 11 illustrates an egress node 1014 allocating virtual private network (VPN) SIDs for in-band loss performance measurement, according to an additional embodiment. In this embodiment, egress node 1014 may account for incoming traffic using different VPN SIDs that are allocated by egress node 1014. For example, a first VPN SID 1016 (e.g., VPN SID A4:400::101) is allocated by egress node 1014 to account for traffic received from a first node 1011 and a second VPN SID 1018 (e.g., VPN SID A4:400::102) is allocated by egress node 1014 to account for traffic received from a second node 1012. With this arrangement, one policy (e.g., SRv6 policy for loss performance measurement) can send traffic on multiple VPN SIDs (e.g., first VPN SID 1016 and second VPN SID 1018).

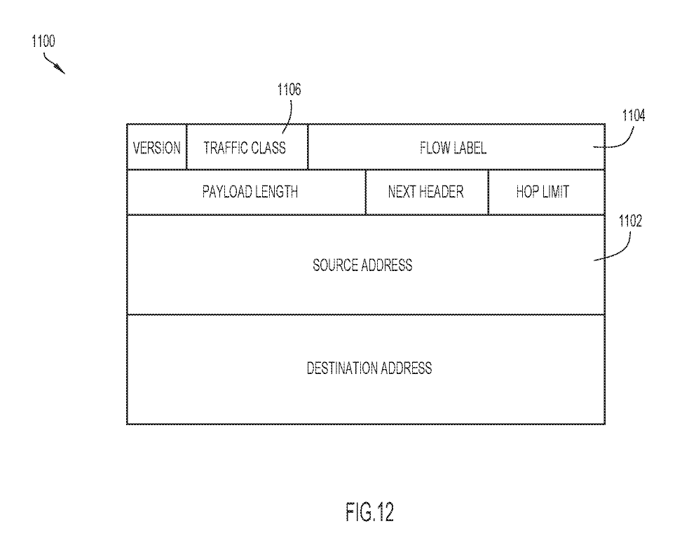

FIG. 12 illustrates a packet header 1100 including a flow label field 1104 and a traffic class field 1106, a selected bit of which is repurposed as part of the mechanism for in-band loss performance measurement presented herein, according to an additional embodiment. In this embodiment, packet header 1100 includes a source address field 1102. In contrast to some previous embodiments, for example, packet header 200 and/or packet header 600, described above, in this embodiment, source address field 1102 of packet header 1100 is not used as part of the mechanism for in-band loss performance measurement. Instead, in this embodiment, flow label field 1104 is used in place of flow-ID. However, the flow label field 1104 is not unique on a per policy basis, i.e., a given SRv6 policy can carry traffic from multiple sources and different flows can have different flow-IDs. Due to size limitations associated with flow label field 1104 (i.e., 20 bits), a bit from this field cannot be used for an identifier for the indicator/color of packets. As a result, in this embodiment, traffic class field 1106 may include a single bit that is used for an identifier for an indicator/color assigned to a packet.

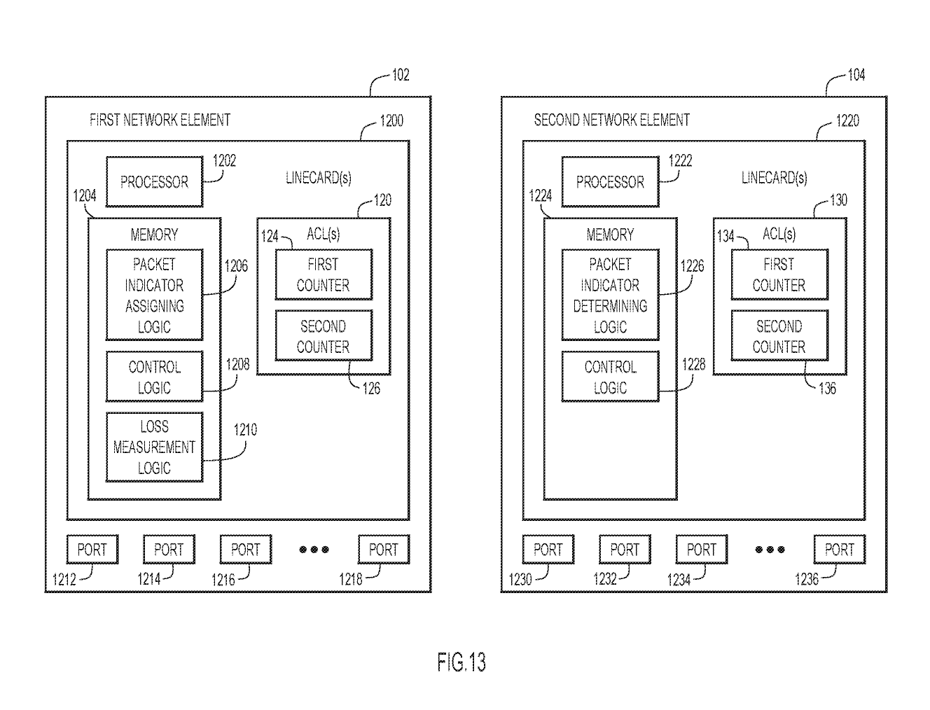

FIG. 13 is a block diagram of a representative ingress node (e.g., first network element 102) and a representative egress node (e.g., second network element 104) configured to perform techniques for in-band loss performance measurement in network 100, according to an example embodiment. Other nodes in network 100 may have a similar configuration to perform these in-band loss performance measurement techniques. First network element 102 may include a linecard 1200. While one linecard 1200 is shown in FIG. 13, it is to be understood that a network element or node, including first network element 102 and/or second network element 104, may have multiple linecards.

Linecard 1200 may include a processor 1202 and a memory 1204. Linecard 1200 may also include additional components not shown in FIG. 13, such as a ternary content-addressable memory (TCAM), a Media Access Control (MAC) table, and an L2/L3 Forwarding Engine. These components may be embodied as a hardware ASIC in some embodiments. Various operations of a node, including an ingress node or egress node (e.g., first network element 102 and second network element 104) described above may be embodied by instructions stored in memory 1204 and executed by processor 1202. For example, memory 1204 may include instructions for implementing one or more of a packet indicator assigning logic 1206, operation or control logic 1208, and/or a loss measurement logic 1210 to implement various operations of first network element 102 described above in reference to FIGS. 1-12.

In an example embodiment, packet indicator assigning logic 1206 may include one or more operations for assigning an indicator/color to packets of a plurality of packets associated with a packet flow or traffic, including toggling between two indicators/colors over successive measurement intervals, as described above, when executed by processor 1202. Operation or control logic 1208 may include instructions for operating first network element 102 when executed by processor 1202. In addition, loss measurement logic 1210 may include one or more operations for determining loss measurement values, including sending and receiving probe packets (e.g. probe query packet 400), as described above, when executed by processor 1202.

Linecard 1200 may also include stored table or data structure 120 that includes first counter 124 configured to count a number of packets assigned to a first indicator or color (e.g., CNT0), and second counter 126 configured to count a number of packets assigned to a second indicator or color (e.g., CNT1). As described above, in some embodiments, first counter 124 and second counter 126 may be established via ACLs associated with the SRv6 policy for loss performance measurement from network controller 110.

First network element 102 may also include a plurality of network ports 1212, 1214, 1216, 1218, which may include uplink and/or downlink ports, at which ingress traffic is received at first network element 102 and from which egress traffic is transmitted from first network element 102. The number of ports shown in FIG. 13 is only by way of example and it should be understood that there may be more or fewer ports on first network element 102.

Second network element 104 may have a similar configuration as first network element 102. In this embodiment, second network element 104 includes a linecard 1220 having a processor 1222 and a memory 1224. Linecard 1220 may also include additional components not shown in FIG. 13, such as a ternary content-addressable memory (TCAM), a Media Access Control (MAC) table, and an L2/L3 Forwarding Engine. These components may be embodied as a hardware ASIC in some embodiments. Various operations of a node, including an ingress node or egress node (e.g., first network element 102 and second network element 104) described above may be embodied by instructions stored in memory 1224 and executed by processor 1222. For example, memory 1224 may include instructions for implementing one or more of a packet indicator determining logic 1226 and/or operation or control logic 1228 to implement various operations of second network element 104 described above in reference to FIGS. 1-12.

In an example embodiment, packet indicator determining logic 1226 may include one or more operations for determining the indicator/color assigned to received packets of a plurality of packets associated with a packet flow or traffic, as described above, when executed by processor 1222. Operation or control logic 1228 may include instructions for operating second network element 104 when executed by processor 1222.

Linecard 1220 may also include stored table or data structure 130 that includes first counter 134 configured to count a number of packets assigned to a first indicator or color (e.g., CNT0), and second counter 136 configured to count a number of packets assigned to a second indicator or color (e.g., CNT1). As described above, in some embodiments, first counter 134 and second counter 136 may be established via ACLs associated with the SRv6 policy for loss performance measurement from network controller 110.

Second network element 104 also includes a plurality of network ports 1230, 1232, 1234, 1236, which may include uplink and/or downlink ports, at which ingress traffic is received at second network element 104 and from which egress traffic is transmitted from second network element 104. The number of ports shown in FIG. 13 is only by way of example and it should be understood that there may be more or fewer ports on second network element 104.

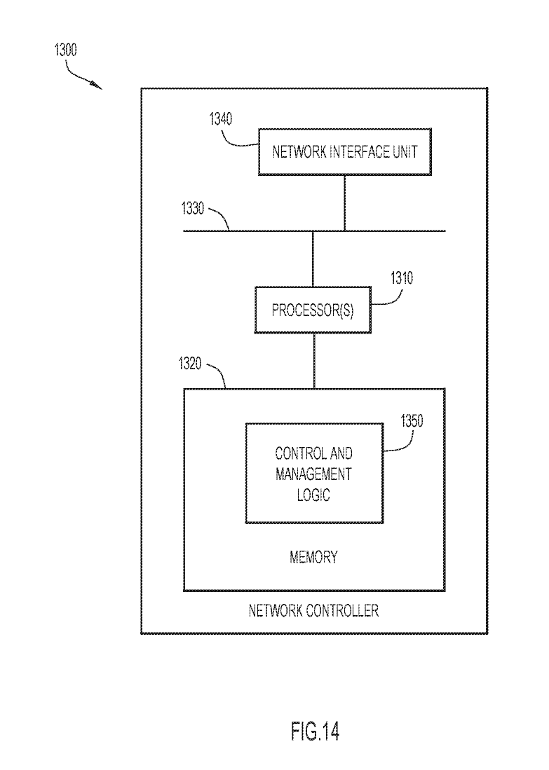

Reference is now made to FIG. 14. FIG. 14 illustrates a block diagram of a computing/control entity 1300 that may perform the functions of network controller 110 shown in FIGS. 1 and 4. The computing/control entity 1300 includes one or more processors 1310, memory 1320, a bus 1330 and a network interface unit 1340, such as one or more network interface cards that enable network connectivity. The memory 1320 stores instructions for control and management logic 1350, that when executed by the processor 1310, cause the processor to perform the software defined network controller operations described herein.

The memory 1320 may include ROM of any type now known or hereinafter developed, RAM of any type now known or hereinafter developed, magnetic disk storage media devices, tamper-proof storage, optical storage media devices, flash memory devices, electrical, optical, or other physical/tangible memory storage devices. In general, the memory 1320 may comprise one or more tangible (non-transitory) computer readable storage media (e.g., a memory device) encoded with software comprising computer executable instructions and when the software is executed (by the processor 1310) it is operable to perform the network controller operations described herein.

According to the principles of the example embodiments described herein, mechanisms are provided for “direct mode” (i.e., in-band) performance loss measurement in Internet Protocol version 6/Segment Routing version 6 (IPv6/SRv6) software defined networks (SDNs) where packet loss is measured directly in the data plane. In the example embodiments, some of the bits in a source address of an outer IPv6 header of a packet are used to uniquely identify the traffic flow (i.e., an SRv6 policy). A bit in source address of the outer IPv6 header can also be toggled by a source (i.e., ingress) node for coloring data traffic. Access Control Lists (ACLs) are attached to the SRv6 policies by a centralized controller to count traffic for two indicators/colors using the source address field of the IPv6 header to uniquely identify the traffic flows (i.e. , SRv6 policies) in the network. The centralized controller may then use the received packets/bytes counters for the 2 different indicators/colors to detect performance traffic loss for the SRv6 policy.

The techniques for in-band loss performance measurement presented herein do not require disabling of Penultimate Segment Popping (PSP) behavior for SRv6 policies for coloring and accounting traffic.

Additionally, toggling of indicators/colors for traffic can easily be accomplished in hardware, where Linecards include one memory location that stores a source address.

The example embodiments describe using ACL based counters that leverage existing network infrastructure software across operating systems and platforms and are widely used by customers.

In summary, a method is provided comprising: assigning, at a first network element, one of a first indicator or a second indicator to a first plurality of packets; transmitting, from the first network element, the first plurality of packets over a first measurement interval, wherein the first network element includes a first counter that measures a number of packets of the first plurality of packets transmitted by the first network element during the first measurement interval; receiving, at a second network element, one or more packets from the first network element; determining, by the second network element, whether the received one or more packets are assigned the first indicator or the second indicator; wherein the second network element includes a first counter that measures a number of packets received by the second network element that are assigned the first indicator and a second counter that measures a number of packets received by the second network element that are assigned the second indicator; and determining a loss measurement value for the first plurality of packets based on a difference between the number of packets measured by the first counter of the first network element and the number of packets measured by one of the first counter or the second counter of the second network element.

In another form, a non-transitory computer readable storage media encoded with instructions that, when executed by a processor of a first network element, cause the processor to: assign one of a first indicator or a second indicator to a first plurality of packets; transmit the first plurality of packets over a first measurement interval, wherein the first network element includes a first counter that measures a number of packets of the first plurality of packets transmitted by the first network element during the first measurement interval; wherein the first plurality of packets are configured to be received at a second network element, the second network element including a first counter for measuring a number of packets received by the second network element that are assigned the first indicator and a second counter for measuring a number of packets received by the second network element that are assigned the second indicator; and determine a loss measurement value for the first plurality of packets based on a difference between the number of packets measured by the first counter of the first network element and the number of packets measured by one of the first counter or the second counter of the second network element.

Furthermore, an apparatus is provided comprising: a plurality of network ports configured to receive inbound packets and to send outbound packets; a memory; a processor coupled to the memory and to the plurality of network ports, wherein the processor is configured to: assign one of a first indicator or a second indicator to a first plurality of packets; transmit the first plurality of packets over a first measurement interval, wherein the apparatus includes a first counter that measures a number of packets of the first plurality of packets transmitted during the first measurement interval; wherein the first plurality of packets are configured to be received at a network element, the network element including a first counter for measuring a number of packets received by the network element that are assigned the first indicator and a second counter for measuring a number of packets received by the network element that are assigned the second indicator; and determine a loss measurement value for the first plurality of packets based on a difference between the number of packets measured by the first counter of the apparatus and the number of packets measured by one of the first counter or the second counter of the network element.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
assigning, at a first network element, one of a first indicator or a second indicator to a first plurality of packets;
transmitting, from the first network element, the first plurality of packets over a first measurement interval, wherein the first network element includes a first counter that measures a number of packets of the first plurality of packets transmitted by the first network element during the first measurement interval;
receiving, at a second network element, one or more packets from the first network element;
determining, by the second network element, whether the received one or more packets are assigned the first indicator or the second indicator;
wherein the second network element includes a first counter that measures a number of packets received by the second network element that are assigned the first indicator and a second counter that measures a number of packets received by the second network element that are assigned the second indicator; and
determining a loss measurement value for the first plurality of packets based on a difference between the number of packets measured by the first counter of the first network element and the number of packets measured by one of the first counter or the second counter of the second network element.

2. The method of claim 1, wherein the first plurality of packets are assigned the first indicator, and wherein the method further comprises:
assigning, at the first network element, the second indicator to a second plurality of packets; and
transmitting, from the first network element, the second plurality of packets over a second measurement interval, wherein the first network element includes a second counter that measures a number of packets of the second plurality of packets transmitted by the first network element during the second measurement interval.

3. The method of claim 2, further comprising:
determining a loss measurement value for the second plurality of packets based on a difference between the number of packets measured by the second counter of the first network element and the number of packets measured by the second counter of the second network element.

4. The method of claim 1, further comprising the first network element toggling between assigning packets to the first indicator or the second indicator over successive measurement intervals.

5. The method of claim 1, further comprising a network controller for a network comprising a plurality of network elements, including at least the first network element and the second network element, wherein the method further comprises:
instantiating, by the network controller, a policy for assigning one of the first indicator or the second indicator to packets transmitted from the first network element.

6. The method of claim 5, wherein the policy is identified by a policy identifier included in a header of the first plurality of packets and the second plurality of packets.

7. The method of claim 1, wherein an identifier of the first indicator or the second indicator is included in a header of the first plurality of packets.

8. The method of claim 1, further comprising:
transmitting, by the first network element, a probe packet to the second network element, wherein the probe packet includes a request for the number of packets measured by at least one of the first counter or the second counter of the second network element.

9. One or more non-transitory computer readable storage media encoded with instructions that, when executed by a processor of a first network element, cause the processor to:
assign one of a first indicator or a second indicator to a first plurality of packets;
transmit the first plurality of packets over a first measurement interval, wherein the first network element includes a first counter that measures a number of packets of the first plurality of packets transmitted by the first network element during the first measurement interval;
wherein the first plurality of packets are configured to be received at a second network element, the second network element including a first counter for measuring a number of packets received by the second network element that are assigned the first indicator and a second counter for measuring a number of packets received by the second network element that are assigned the second indicator; and
determine a loss measurement value for the first plurality of packets based on a difference between the number of packets measured by the first counter of the first network element and the number of packets measured by one of the first counter or the second counter of the second network element.

10. The one or more non-transitory computer readable storage media of claim 9, wherein the first plurality of packets are assigned the first indicator, and further comprising instructions that cause the processor to:
assign the second indicator to a second plurality of packets; and
transmit the second plurality of packets over a second measurement interval, wherein the first network element includes a second counter that measures a number of packets of the second plurality of packets transmitted by the first network element during the second measurement interval.

11. The one or more non-transitory computer readable storage media of claim 10, further comprising instructions that cause the processor to:
determine a loss measurement value for the second plurality of packets based on a difference between the number of packets measured by the second counter of the first network element and the number of packets measured by the second counter of the second network element.

12. The one or more non-transitory computer readable storage media of claim 9, wherein the instructions cause the processor to toggle between assigning packets to the first indicator or the second indicator over successive measurement intervals.

13. The one or more non-transitory computer readable storage media of claim 9, wherein an identifier of the first indicator or the second indicator is included in a header of the first plurality of packets.

14. The one or more non-transitory computer readable storage media of claim 9, further comprising instructions that cause the processor to:
transmit a probe packet to the second network element, wherein the probe packet includes a request for the number of packets measured by at least one of the first counter or the second counter of the second network element.

15. An apparatus comprising:
a plurality of network ports configured to receive inbound packets and to send outbound packets;
a memory;
a processor coupled to the memory and to the plurality of network ports, wherein the processor is configured to:
assign one of a first indicator or a second indicator to a first plurality of packets;
transmit the first plurality of packets over a first measurement interval, wherein the apparatus includes a first counter that measures a number of packets of the first plurality of packets transmitted during the first measurement interval;
wherein the first plurality of packets are configured to be received at a network element, the network element including a first counter for measuring a number of packets received by the network element that are assigned the first indicator and a second counter for measuring a number of packets received by the network element that are assigned the second indicator; and
determine a loss measurement value for the first plurality of packets based on a difference between the number of packets measured by the first counter of the apparatus and the number of packets measured by one of the first counter or the second counter of the network element.

16. The apparatus of claim 15, wherein the first plurality of packets are assigned the first indicator, and wherein the processor is further configured to:
assign the second indicator to a second plurality of packets; and
transmit the second plurality of packets over a second measurement interval, wherein the apparatus includes a second counter that measures a number of packets of the second plurality of packets transmitted during the second measurement interval.

17. The apparatus of claim 16, wherein the processor is further configured to:
determine a loss measurement value for the second plurality of packets based on a difference between the number of packets measured by the second counter of the apparatus and the number of packets measured by the second counter of the network element.

18. The apparatus of claim 15, wherein the processor is further configured to toggle between assigning packets to the first indicator or the second indicator over successive measurement intervals.

19. The apparatus of claim 15, wherein an identifier of the first indicator or the second indicator is included in a header of the first plurality of packets.

20. The apparatus of claim 15, wherein the processor is further configured to:
transmit a probe packet to the network element, wherein the probe packet includes a request for the number of packets measured by at least one of the first counter or the second counter of the network element.
